(19) United States
(12) Patent Application Publication
(10) Pub. No.: US 2009/0022979 A1
(43) Pub. Date: Jan. 22, 2009

(54) Anti-slip floor coating composition and anti-slip floor material made therefrom

(76) Inventor: Sube Tsai, Kaohsiung City (TW)

Correspondence Address: HARNESS, DICKEY & PIERCE, P.L.C., P.O. BOX 8910, RESTON, VA, 20195, US

(21) Appl. No.: 11/826,738

(22) Filed: Jul. 18, 2007

(51) Int. Cl. B32B 5/16; C09K 3/14

(52) U.S. Cl. 428/325; 106/36; 428/323

(57) ABSTRACT

An anti-slip floor coating composition includes an acrylic resin, an inorganic additive including particles that range in size from 20 to 600 microns, and cement powder. An anti-slip floor material includes a base layer of the anti-slip floor coating composition and an anti-slip-enhancing layer formed on the base layer and having an anti-slip material composition including a resin material and a particulate additive.

### BACKGROUND OF THE INVENTION

1. Field of the Invention

This invention relates to an anti-slip floor coating composition and an anti-slip floor material made therefrom, more particularly to an anti-slip floor coating composition including an acrylic resin, particles of an inorganic additive, and cement powder.

2. Description of the Related Art

U.S. Pat. No. 5,431,960 discloses an anti-slip floor coating composition that includes water, a plasticizer portion, an acrylic polymer portion, an additive portion, and particles. The anti-slip floor coating composition is effective in slip-resistance for a wet or contaminated floor. However, there is still a need for a floor coating composition that, when applied, can exhibit excellent slip resistance, wearing resistance, chemical resistance, and adhesion.

### SUMMARY OF THE INVENTION

Therefore, the object of the present invention is to provide an anti-slip floor coating composition that, when applied, can provide excellent slip resistance, wearing resistance, chemical resistance, and adhesion.

Another object of the present invention is to provide an anti-slip floor material made from the anti-slip floor coating composition.

According to one aspect this invention, there is provided an anti-slip floor coating composition that comprises an acrylic resin, an inorganic additive including particles that range in size from 20 to 600 microns, and cement powder.

According to another aspect this invention, there is provided an anti-slip floor material that comprises a base layer of a coating composition and an anti-slip-enhancing layer formed on the base layer and having an anti-slip material composition. The coating composition comprises an acrylic resin, an inorganic additive including particles that range in size from 20 to 600 microns, and cement powder. The anti-slip material composition comprises a resin material and a particulate additive.

### BRIEF DESCRIPTION OF THE DRAWING

Other features and advantages of the present invention will become apparent in the following detailed description of the preferred embodiments of this invention, with reference to the accompanying drawing, in which:

FIG. 1 is a schematic sectional view of the preferred embodiment of a floor tile according to this invention; and

FIG. 2 is a perspective view to illustrate a bathroom floor provided with the floor tile of this invention.

### DETAILED DESCRIPTION OF THE PREFERRED EMBODIMENTS

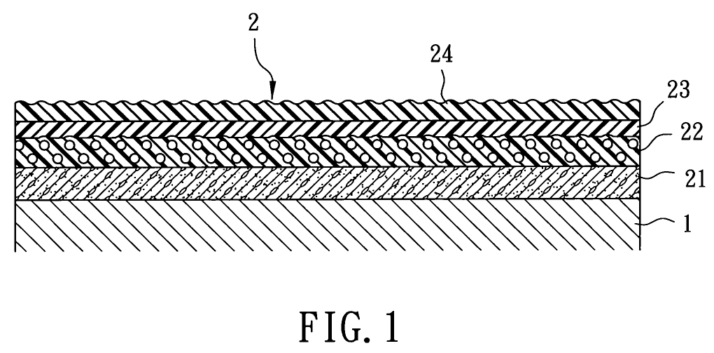

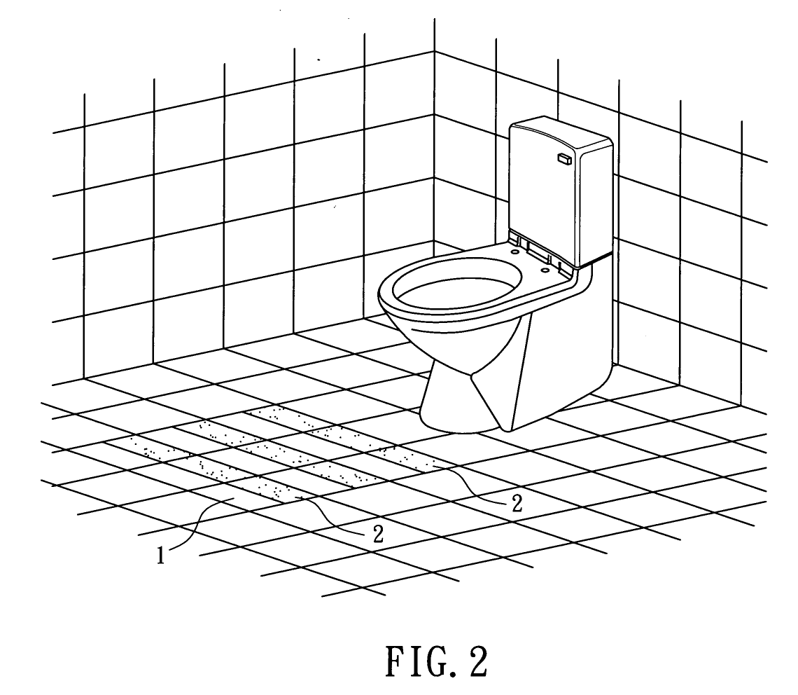

FIG. 1 illustrates the preferred embodiment of a floor tile according to this invention for application to a floor (see FIG. 2), such as a bathroom floor, a kitchen floor, a stair floor, and the like.

The floor tile includes: a floor substrate 1 and an anti-slip floor material 2 formed on the floor substrate 1. The anti-slip floor material 2 includes a transparent base layer 21 formed on the floor substrate 1 and having an anti-slip floor coating composition, and a transparent anti-slip-enhancing layer 22 formed on the base layer 21 and having an anti-slip material composition. The anti-slip coating composition comprises an acrylic resin, an inorganic additive including particles that range in size from 20 to 600 microns, and cement powder. The anti-slip material composition comprises a resin material and a particulate additive.

Examples of the acrylic resin include methylacrylate, ethylacrylate, butylacrylate, and octylacrylate. Examples of the resin material include epoxy resin, polyurethane resin, acrylic resin, and acrylic resin-based paint.

Examples of the inorganic additive and the particulate additive include ceramic, glass, quartz, and emery.

The anti-slip floor material 2 may optionally further include: a cover layer 23 that is formed on the anti-slip-enhancing layer 22 and that is made from a material selected from at least one of epoxy resin and acrylic resin-based paint; and a protective layer 24 that is formed on the cover layer 23 and that is made from acrylic resin-based paint.

In one embodiment, the inorganic additive is in an amount ranging from 2 to 4 wt %, the cement powder is in an amount ranging from 45 to 75 wt %, and the acrylic resin comprises the balance of the coating composition. The particulate additive is in an amount ranging from 40 to 60 wt %, and the resin material comprises the balance of the anti-slip material composition. The inorganic additive further includes short glass fiber. The particles of the inorganic additive are made from quartz, and range in size from about 100 to about 450 microns, or have a size of −100 mesh, −60 mesh, or −40 mesh (the symbol “−” represents particles passing through the mesh screen). The particulate additive of the anti-slip material composition preferably includes quartz particles that preferably have a size in one of −100 mesh, −60 mesh, or −40 mesh.

In another embodiment, the anti-slip floor coating composition may further comprise water. As such, the weight ratio of the acrylic resin : the mixture of the cement powder and the inorganic additive:the water ranges from 5.5:1:1 to 4.5:1:1. In this embodiment, the particles of the inorganic additive preferably include white quartz particles and white hollow particles of a material selected from at least one of glass and ceramic. Preferably, the weight ratio of the cement powder:the hollow particles:the quartz particles ranges from 2:1:2 to 1.5:1:1.5. The hollow particles of the inorganic additive range in size from 70 to 150 microns or have a size such that they can pass through 100 to 200 mesh screen, and the quartz particles of the inorganic additive range in size from 30 to 200 microns or have a size such that they can pass through 80 to 200 mesh screen or 300 to 500 mesh screen or have a combination of the size that can pass through 80 to 200 mesh screen and the size that can pass through 300 to 500 mesh screen. In this embodiment, the resin material of the anti-slip material composition is an acrylic resin-based paint. The particulate additive can be a combination of the white hollow particles and white quartz particles or a combination of the white hollow particles and glass particles. The weight ratio of the acrylic resin-based paint:the quartz particles or the glass particles of the particulate additive: the hollow particles of the particulate additive ranges from 100:10:1 to 100:30:5. The hollow particles of the particulate additive range in size from 70 to 150 microns or have a size such that they can pass through 100 to 200 mesh screen, and the quartz or glass particles of the particulate additive range in size from 300 to 600 microns or have a size such that they can pass through 30 to 50 mesh screen.

In yet another embodiment, the weight ratio of the resin material to the particulate additive ranges from 10:5 to 10:1, and the white quartz particles range in size from 170 to 300 microns, or have a size such that they can pass through 50 to 80 mesh screen.

With the inclusion of the cement powder in the anti-slip floor coating composition of this invention, application of this invention can provide improved slip resistance, wearing resistance, chemical resistance, and adhesion as compared to the aforesaid conventional anti-slip floor coating composition. Moreover, with the inclusion of the short glass fiber in the anti-slip floor coating composition of this invention, the material strength and the wearing resistance can be enhanced.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. An anti-slip floor coating composition comprising:
an acrylic resin;
an inorganic additive including particles that range in size from 20 to 600 microns; and
cement powder.

2. The anti-slip floor coating composition of claim 1, wherein said inorganic additive is in an amount ranging from 2 to 4 wt %, said cement powder is in an amount ranging from 45 to 75 wt %, and said acrylic resin comprises the balance of said anti-slip floor coating composition.

3. The anti-slip floor coating composition of claim 2, wherein said inorganic additive further includes short glass fiber.

4. The anti-slip floor coating composition of claim 3, wherein said particles of said inorganic additive are made from a material selected from at least one of ceramic, glass, quartz, and emery.

5. The anti-slip floor coating composition of claim 4, wherein said particles of said inorganic additive are made from quartz, and range in size from 100 to 450 microns.

6. The anti-slip floor coating composition of claim 1, wherein said acrylic resin is selected from the group consisting of methylacrylate, ethylacrylate, butylacrylate, and octylacrylate.

7. The anti-slip floor coating composition of claim 1, further comprising water, the weight ratio of said acrylic resin:the mixture of said cement powder and said inorganic additive:said water ranging from 5.5:1:1 to 4.5:1:1.

8. The anti-slip floor coating composition of claim 7, wherein said particles of said inorganic additive include quartz particles and hollow particles of a material selected from at least one of glass and ceramic, said quartz particles ranging in size from 30 to 200 microns, said hollow particles ranging in size from 70 to 150 microns.

9. The anti-slip floor coating composition of claim 8, wherein the weight ratio of said cement powder:said hollow particles:said quartz particles ranges from 2:1:2 to 1.5:1:1.5.

10. An anti-slip floor material comprising:
a base layer of a coating composition that comprises an acrylic resin, ‘an inorganic additive including particles that range in size from 20 to 600 microns, and cement powder; and
an anti-slip-enhancing layer formed on said base layer and having an anti-slip material composition that comprises a resin material and a particulate additive.

11. The anti-slip floor material of claim 10, wherein said inorganic additive is in an amount ranging from 2 to 4 wt %, said cement powder is in an amount ranging from 45 to 75 wt %, and said acrylic resin comprises the balance of said coating composition.

12. The anti-slip floor material of claim 10, wherein said particulate additive is in an amount ranging from 40 to 60 wt %, and said resin material comprises the balance of said anti-slip material composition.

13. The anti-slip floor material of claim 10, wherein said resin material is selected from at least one of epoxy resin, polyurethane resin, acrylic resin, and acrylic resin-based paint.

14. The anti-slip floor material of claim 10, wherein the weight ratio of said resin material to said particulate additive ranges from 10:5 to 10:1.

15. The anti-slip floor material of claim 10, further comprising a cover layer formed on said anti-slip-enhancing layer and made from a material selected from at least one of epoxy resin and acrylic resin-based paint.

16. The anti-slip floor material of claim 15, further comprising a protective layer formed on said cover layer and made from acrylic resin-based paint.

17. The anti-slip floor material of claim 10, wherein said particulate additive is made from a material selected from at least one of glass, ceramic, quartz, and emery.

18. The anti-slip floor material of claim 10, wherein said particulate additive includes hollow particles and quartz particles, said hollow particles being made from a material selected from at least one of glass and ceramic and ranging in size from 70 to 150 microns, said quartz particles ranging in size from 300 to 600 microns.

19. The anti-slip floor material of claim 18, wherein said resin material is acrylic resin-based paint, the weight ratio of said acrylic resin-based paint:said quartz particles:said hollow particles ranging from 100:10:1 to 100:30:1.

20. The anti-slip floor material of claim 10, wherein said particulate additive includes hollow particles and glass particles, said hollow particles being made from a material selected from at least one of glass and ceramic and ranging in size from 70 to 150 microns, said glass particles ranging in size from 300 to 600 microns.

21. The anti-slip floor material of claim 20, wherein said resin material is acrylic resin-based paint, the weight ratio of said acrylic resin-based paint:said glass particles:said hollow particles ranging from 100:10:1 to 100:30:1.

22. The anti-slip floor material of claim 10, wherein said inorganic additive further includes short glass fiber.

23. The anti-slip floor material of claim 22, wherein said particles of said inorganic additive are made from a material selected from at least one of ceramic, glass, quartz, and emery.

24. The anti-slip floor material of claim 23, wherein said particles of said inorganic additive are made from quartz, and range in size from 100 to 450 microns.

25. The anti-slip floor material of claim 10, wherein said acrylic resin is selected from the group consisting of methylacrylate, ethylacrylate, butylacrylate, and octylacrylate.

26. The anti-slip floor material of claim 10, further comprising water, the weight ratio of said acrylic resin the mixture of said cement powder and said inorganic additive:said water ranging from 5.5:1:1 to 4.5:1:1.

27. The anti-slip floor material of claim 26, wherein said particles of said inorganic additive include quartz particles and hollow particles of a material selected from at least one of glass and ceramic, said quartz particles ranging in size from 30 to 200 microns, said hollow particles ranging in size from 70 to 150 microns.

28. The anti-slip floor material of claim 27, wherein the weight ratio of said cement powder:said hollow particles said quartz particles ranges from 2:1:2 to 1.5:1:1.5.
